(19) United States
(12) Patent Application Publication
(10) Pub. No.: US 2014/0184249 A1
(43) Pub. Date: Jul. 3, 2014

(54) SMART PAINT

(71) Applicant: UNIVERSITY OF STRATHCLYDE, Glasgow (GB)

(72) Inventors: Mohamed Saafi, Glasgow (GB); David McGahon, Glasgow (GB)

(73) Assignee: UNIVERSITY OF STRATHCLYDE, Glasgow (GB)

(21) Appl. No.: 13/729,449

(22) Filed: Dec. 28, 2012

(51) Int. Cl. G01N 27/20; C09D 5/24

(52) U.S. Cl. CPC G01N 27/20; C09D 5/24; Y10S 977/734; B82Y 99/00
USPC 324/693; 252/500; 252/502; 252/521.3; 324/76.11; 977/734

(57) ABSTRACT

A condition monitoring paint is formed of a base material, and conductive components for forming a conductive network. The conductive components may include nano-particles or nano-structures. The paint in used in a condition monitoring system for monitoring the integrity or condition of structures, such as bridges.

### FIELD OF THE INVENTION

The present invention relates to paint for use in a conditioning monitoring system for monitoring the condition of structures. In addition, the invention relates to a conditioning monitoring system that includes such paint.

### BACKGROUND OF THE INVENTION

Monitoring structural integrity is very important but during and after construction, but can be difficult to do in practice. Systems that use sensors that are attached or embedded in the structure that is to be monitored are known. Some of these sensors are semiconductor based and contain electronics. Therefore, they must be sealed to protect them from harsh environments in materials such as concrete and soil. Hence, they are expensive to produce and require complex manufacturing process. In addition, these sensors provide only local damage detection, thus a large number of them is required to monitor large areas of a structure.

Another known embeddable sensor uses fiber optics. Fiber optic sensors are used to measure strain and moisture inside concrete based on a Bragg grating written in an optical fiber with a moisture sensitive coating. Fiber optic sensors are extremely expensive and are very brittle and may break during installation. Also, measurement of strain and moisture using fiber optic sensors requires expensive and large equipment. Connecting fiber optic sensors to equipment is difficult and challenging. Fiber optic sensors are also sensitive to temperature.

### SUMMARY OF THE INVENTION

According to one aspect of the present invention, there is provided a condition monitoring paint comprising a base material, and conductive components for forming a conductive network. The conductive components may be for example carbon particles. The conductive components may comprise nano-particles or nano-structures for forming a conductive network. Preferably, the nano-particles comprise carbon nano-tubes or graphenes. For example the conductive components may comprise one or more of graphene, graphene oxide, carbon nanotubes, carbon nanofibers, and textile fibres coated with carbon nanotubes or graphene or graphene oxide.

The base material comprises a material that is compatible with the structure to which it has to be applied. For example, when the paint has to be used with concrete, the base material may comprise a concrete or material that is compatible with concrete such as an aluminosilicate, for example an alkali-activated geopolymer. The base material may comprise any aluminosilicate material, but preferably low calcium fly ash or an amorphous aluminosilicate powder. A mixture of an alumina and silica powders may be employed as the source of aluminosilicate. More generally at least one inorganic alumino-silicate material such as low-calcium fly-ash, clay, alumino-silicate rock powder, kaolin or alumino-silicate slag powder from steel manufacture or similar powders may be employed.

Geopolymers are alkali-activated solids produced by reaction between an alkali and an aluminosilicate material or a mixture of an alumina and a silica. The geopolymer is a solid formed by reaction of the source alumina and silica containing material with alkali.

The polymerisation process typically includes: dissolution of Si and Al atoms from the source material due to hydroxide ions in solution, reorientation of precursor ions in solution, and setting via polycondensation reactions into an inorganic “polymer” (actually a crystalline-like lattice).

The inorganic polymer network is in general a highly-coordinated 3-dimensional aluminosilicate gel, with the negative charges on tetrahedral Al(III) sites charge-balanced by alkali metal cations. Such materials are in general compatible with concrete and may contain less water than a conventional calcium containing concrete, where a significant amount of water is present in the set structure.

The paint may also include a binding agent for binding the base material and the nano-particles or nano-structures together. For example a polymer or resin may be used as a binding agent.

If the base material for the paint is an alkali activated geopolymer, an alkaline binding agent conveniently reacts with aluminosilicate material to provide a set geopolymer as a matrix for the conductive components and any other components of the paint. To form a geopolymer the alkaline binding agent may comprise aqueous sodium silicate and/or sodium hydroxide and/or potassium silicate and/or potassium hydroxide. Advantageously a mixture of sodium and/or potassium silicate is employed together with sodium hydroxide and/or potassium hydroxide. The use of sodium hydroxide or potassium hydroxide in a paint mixture including sodium or potassium silicate has been found to increase the conductivity of the paint when set.

Typical compositions for the paint when the base material is an alkali activated geopolymer may comprise from 65% to 80% by weight aluminosilicate (generally as a dry powder) together with 20 to 35% by weight of aqueous alkaline binder.

Where the conductive components comprise one or more of nano-particles or nano-structures such as graphene, graphene oxide, carbon nanotubes, carbon nanofibers, and textile fibres coated with carbon nanotubes or graphene or graphene oxide; they may be present at up to 0.5% by weight. Typically for these conductive components a low concentration, 0.1% or even substantially lower can provide effective conductivity.

Where textile fibres coated with carbon nanotubes or graphene or graphene oxide are employed as the conductive components, the coated fibres can be prepared by dipping the textile fibres in an aqueous dispersion of carbon nanotubes or graphene or graphene oxide and then drying. The surfactant used to disperse carbon nanotubes or other material to be coated onto textile fibres may comprise a superplasticizer of the type used in concrete applications, for example a polycarboxylate ether superplasticizer. Drying can be for example in a vacuum oven. Alternatives can include coating the fibres by means of an electrospinning process.

Other components may be added to the paint as desired. Typically up to 10% by weight, with one or more (e.g. all) the other components reduced in proportion.

The aqueous alkaline binder employed may be of a concentration of about 25% to 50% by weight of solid alkaline material in water, or even from about 30% to 45% by weight. For example sodium or potassium silicate solutions may be used at about 40% or higher concentration by weight and sodium hydroxide at 10M or 14M (about 30% or 40% concentration by weight). Similar concentrations of potassium hydroxide may be employed. Such relatively concentrated solutions provide a high pH facilitating the formation of the geopolymer, with less water content, to aid drying.

Typically where a silicate and a hydroxide are used together, such as sodium silicate and sodium hydroxide; or potassium silicate and potassium hydroxide; the ratio of silicate solution to hydroxide solution may be of the order of from 3:1 to 2:1 when solutions of comparable strength are mixed to form the alkaline binder or mixed with the other components to form the paint.

To prepare and use the paint, the substances listed above may be simply mixed together, generally in any order. The alkaline binding agent then reacts with the aluminosilicate base material to form a geopolymer that includes the conductive components. Thus the dry components of the mixture may be provided already mixed and the alkaline binding agent added as an aqueous solution at the time when the paint is to be applied to a substrate. Typical mixtures described herein set within about 6 hours, setting can be accelerated if desired by the application of heat, for example steam to the paint coating. The thickness of paint applied to a surface may be varied to suit the circumstances. For example a thickness of about 1 mm may be employed.

According to another aspect of the present invention, there is provided a condition monitoring system for monitoring the condition of a structure, the condition monitoring system comprising condition monitoring, conductive paint according to the first aspect of the invention, and at least two electrodes for measuring an electrical property of the paint.

The system is arranged to measure an electrical property of the paint over time. Changes in the electrical property may be indicative of changes in the structure to which the paint is applied.

The electrical property of the paint may be measured using traditional electronic data acquisition systems. The electrical property may be resistance and/or impedance and/or conductivity. The system may be configured to perform electrical-impedance tomography or electrical-resistance tomography.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Various aspects of the invention will now be described by way of example only and with reference to the accompanying drawings, of which:

FIG. 1 is a view of a system for monitoring the condition of a concrete bridge;

FIG. 2 is an image of the paint that is applied to the bridge of FIG. 1 in a natural unstrained condition, and

FIG. 3 is an electrical-impedance tomography response of the paint of FIG. 2 when attached to a concrete surface in which a micro-crack has formed.

### DETAILED DESCRIPTION OF THE DRAWINGS

The paint of the present invention has a base material that is compatible with the structure to which it has to be applied; conductive components such as nano-particles or nano-structures for forming a conductive network and one or more binding agents. The quantity of nano-particles or nano-structures has to be sufficient to allow a current to flow across an area of interest. This can be determined experimentally.

As an example, the base material may be a mix of fly-ash (a fine-grained waste product from coal-fired power stations); the conductive nano-particles may be carbon nanotubes, i.e. cylindrical molecules made of elemental carbon, and the binding agents may be sodium silicate and sodium hydroxide in an aqueous solution. The resulting paint has properties that are similar to cement. When dry, the fly-ash and binding agent mixture (a geopolymer) acts as a tough coating able to withstand the elements in exposed places. The carbon nanotubes conduct electricity.

In a first example the paint may be formed from a mixture of the following, expressed in % by weight: 55.9% nano-micro amorphous silica and aluminium oxide powder from natural mineral sources with 44% potassium silicate solution as a alkaline binding agent, and 0.1% of PVA (polyvinyl alcohol) fibres coated with graphene oxide. The potassium silicate solution is of the order of 40% potassium silicate by weight in water in this example. The PVA fibres are precoated with graphene oxide by dipping into a suspension of 5 g per litre of graphene oxide in water and drying, before addition to the other components of the paint.

In a second example the paint may be made of 76.9% of low-calcium fly-ash and an alkaline binding agent composed of 17% of sodium hydroxide solution (10M) and 17% of sodium silicate solution (44% by weight in water), 0.1% PVA (polyvinyl alcohol) fibres coated in carbon nanotubes. The carbon nanotubes can be coated onto the PVA fibres in a similar fashion to the graphene oxide. A suspension of 5 g per litre of carbon nanotube solution has the PVA fibres dipped into it for 15 minutes and the fibres are then dried at 40° C. for 8 hours in a vacuum oven.

In a third example the composition is 81.9% of fly-ash, 13% of sodium silicate solution (44% by weight in water) and 5% of sodium hydroxide solution (14 M in water), and 0.1% PVA fibres coated in carbon nanotubes (prepared as for the second example).

Alternative examples can make use of 0.1% by weight of nano carbon fibres solution (5 g per litre) or 0.01% by weight of graphene solution (5 g per litre) in place of the coated PVA fibres. Other quantities of conductive components may be employed. The amount of fly ash, alkaline binding agent or both fly-ash and alkaline binding agent is adjusted to accommodate changes in the amount of conductive components.

Other components may be added to the paint as desired with adjustment of the principal ingredients as appropriate.

In use the paint is applied to the structure that has to be monitored. When applied, the carbon nano-tubes align themselves to form a conductive network. The conductivity of the network of tubes is affected by cracks in, or corrosion of, the painted surface. When put under tensile stress, for example, the nanotubes move further away from each other and the paint becomes less conductive. If inundated by chloride ions, as a result of corrosion by salt water, their conductivity increases. A simple electrical measurement of, for example voltage, allows damage to be monitored.

The electric current running through any part of the painted area can be measured remotely, using an array of electrodes distributed across its surface, and data for the entire structure sent via a central transmitter to a computer. The electrodes may be distributed as a perimeter about a part or all of the painted area. For example, in a regularly spaced array to form a shape such as a circle, square or rectangle. Using a medical-bio-imaging technique called electrical-impedance tomography, a conductivity map of an entire painted structure can be created.

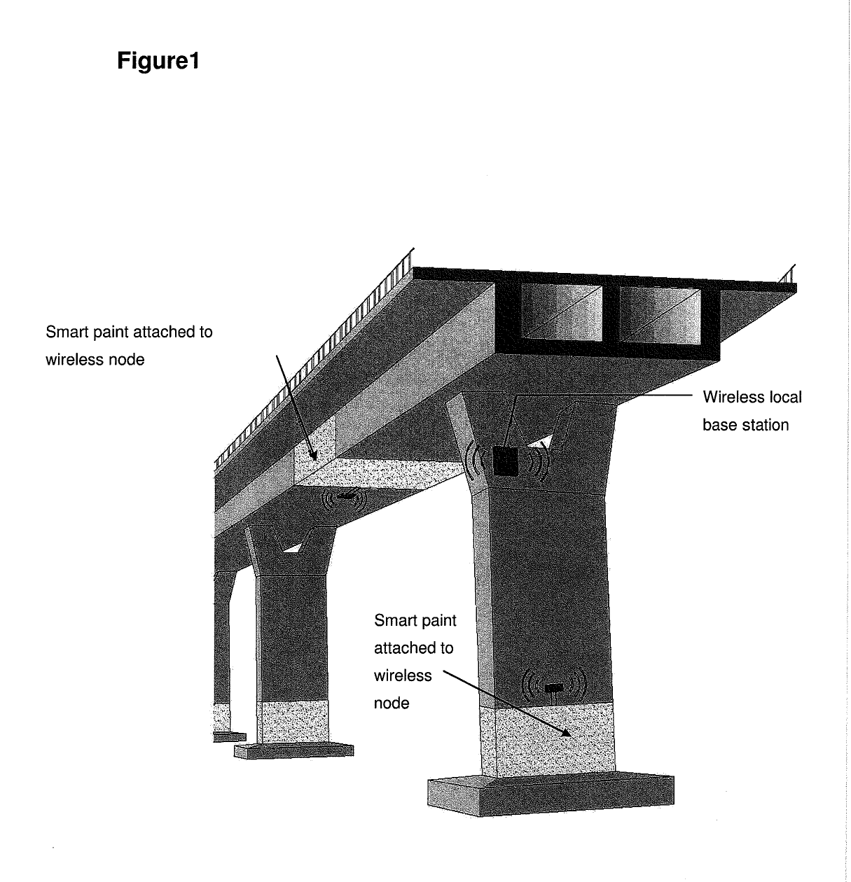

FIG. 1 shows a condition monitoring system for monitoring the condition of a concrete bridge. The paint of the invention is applied to the external concrete surface of the bridge. Electrodes are placed along the perimeter of the paint with a predetermined spacing. The spacing depends on the required resolution, i.e. how precisely any cracks or damage have to be located.

Connected to the electrodes is a wireless node designed to drive current through the paint via the electrodes, measure output voltages between pairs of electrodes and transfer the measured voltages to a wireless local base station for processing. The base station may be attached to the bridge. The processed data is then remotely downloaded to build a conductivity map. The nodes and base stations are equipped with a battery and recharged using a power harvesting system. By monitoring the conductivity of the paint over time, changes in the structure can be detected.

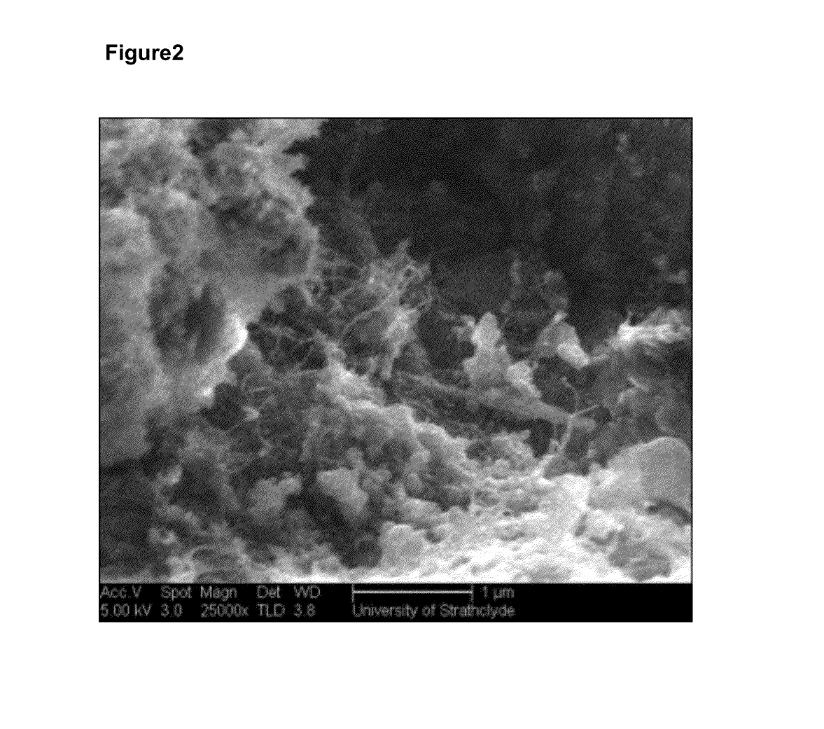

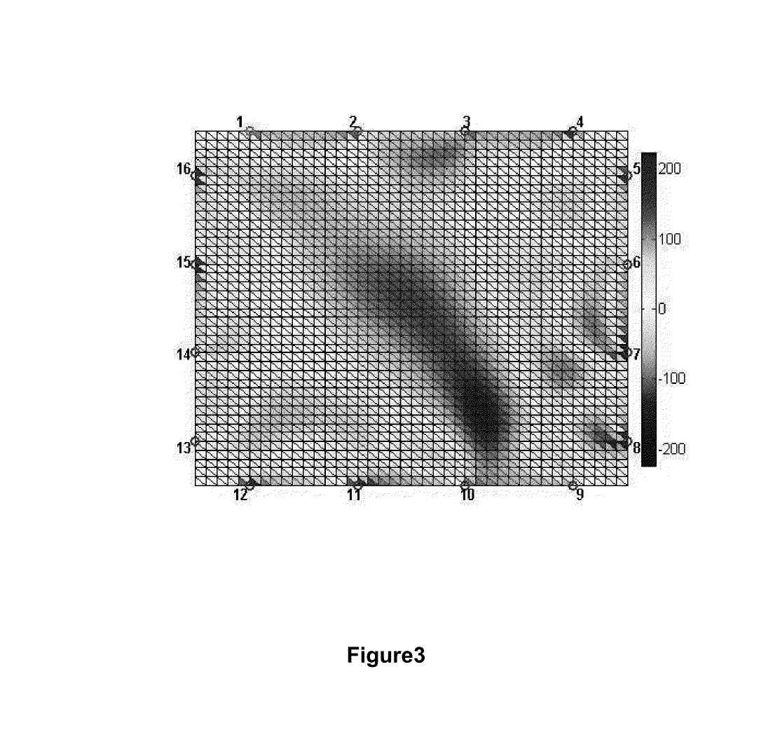

FIG. 2 shows the micro structure of an example paint in an unstrained condition. FIG. 3 shows the electrical-impedance tomography response of the paint attached to a concrete surface when a micro-crack has formed in the concrete substrate. The dark area indicates the shape, location and the length of the micro-crack in the concrete. In a cracked condition, the paint becomes less conductive. Hence, variations in conductivity map are indicative of changes in the structural integrity of the bridge.

The present invention provides a very simple and effective technique for monitoring the physical integrity of structures. The paint can be made of material that is similar to the structures to which it is applied. The paint can be made cheaply and in large volumes. It can be applied in the normal course of structural maintenance.

A skilled person will appreciate that variations of the disclosed arrangements are possible without departing from the scope of the invention. For example, whilst the system of FIG. 1 shows a power supply for powering the paint, a painted structure might itself be able to generate the necessary current for electrical measurements. In particular, for a bridge, power may be captured from the kinetic energy of traffic vibrations. For wind turbines, power may be captured from the turbine's whirling blades. Accordingly the above description of the specific embodiment is made by way of example only and not for the purposes of limitations. It will be clear to the skilled person that minor modifications may be made without significant changes to the operation described.

What is claimed is:

1. A condition monitoring paint comprising a base material, and conductive components for forming a conductive network.

2. The patent as claimed in claim 1 wherein the conductive components comprise nano-particles or nano-structures.

3. The patent as claimed in claim 1 wherein the conductive components comprise carbon particles.

4. The patent as claimed in claim 1 wherein the conductive components comprise one or more of graphene, graphene oxide, carbon nanotubes, carbon nanofibers, textile fibers coated with carbon nanotubes, textile fibers coated with graphene and textile fibers coated with graphene oxide.

5. The patent as claimed in claim 1 comprising a binding agent for binding the base material and the conductive components together.

6. The patent as claimed in claim 1 wherein the base material comprises an aluminosilicate.

7. The patent as claimed in claim 6 further comprising an alkaline binding agent to form a geopolymer with the aluminosilicate.

8. The patent as claimed in claim 7 wherein the alkaline binding agent comprises at least one of sodium silicate, sodium hydroxide, potassium silicate and potassium hydroxide.

9. The patent as claimed in claim 7 comprising from 65% to 80% by weight of aluminosilicate and from 20% to 35% by weight of aqueous alkaline binding agent.

10. A condition monitoring system for monitoring the condition of a structure, the condition monitoring system comprising condition monitoring paint and at least two electrodes for measuring an electrical property of the paint; wherein said condition monitoring paint comprises a base material, and conductive components for forming a conductive network.

11. The system as claimed in claim 10 arranged to measure an electrical property of the paint as a function of time.

12. The system as claimed in claim 11 configured to monitor changes in the measured electrical property and use this as an indication of changes in the structure to which the paint is applied.

13. The system as claimed in claim 10 wherein the electrical property of the paint is measured using an electronic data acquisition system.

14. The system as claimed in claim 10 wherein the electrical property is selected from: resistance and/or impedance and/or conductivity.

15. The system as claimed in claim 10 configured to perform electrical-impedance tomography or electrical-resistance tomography.
